(19) United States
(12) Patent Application Publication
(10) Pub. No.: US 2016/0096463 A1
(43) Pub. Date: Apr. 7, 2016

(54) CLIP FOR FIXING MAT OF VEHICLE CARPET

(71) Applicant: DAEHAN SOLUTION CO., LTD, Icheon (KR)

(72) Inventor: Choong Ho KWON, Seoul (KR)

(73) Assignee: DAEHAN SOLUTION CO., LTD, Incheon (KR)

(21) Appl. No.: 14/891,510

(22) PCT Filed: Oct. 29, 2014
(86) PCT No.: PCT/KR2014/010234

§ 371 Date: Nov. 16, 2015

(30) Foreign Application Priority Data
Nov. 14, 2013 (KR) 10-2013-0138102

(51) Int. Cl. B60N 3/04

(52) U.S. Cl. CPC B60N 3/046

(57) ABSTRACT

A clip for fixing a mat of a carpet of a vehicle that prevents the clip once mounted to a carpet from being detached to improve the coupling force, by fixing the clip to the carpet in the form of a cable tie. In particular, the clip for fixing a mat of a carpet of a vehicle further enhances the coupling force of fixing the clip to the carpet to prevent weakening of the coupling force of the clip or detachment of the clip even when an external force is applied to the carpet, by forming a tongue section to further enhance the coupling force of the clip while being extended as the carpet is pressed on the mat.

### TECHNICAL FIELD

The present invention relates to a clip for fixing a mat of a carpet of a vehicle, and more particularly, to a clip that can be firmly fixed without being detached from the carpet, since the coupling force is improved as the carpet or the mat is pressed, while enhancing a mounting force of the clip to prevent the clip from being separated from a carpet by fixing the clip to the carpet in a cable tie type.

### BACKGROUND ART

In general, when mats are used by being additionally mounted on carpets in a vehicle, clips for fixing the mats are fixedly installed on the carpet, and the mats are fixed by being hooked to the clips. Patent Documents 1 and 2 disclose configurations of clips used to fix mats on carpets in this way.

Patent Document 1 relates to a clip for fixing a mat on a carpet of a vehicle, and discloses the clip that includes a lower plate that is located on a lower surface of the carpet and has insertion grooves formed in a front section; an upper plate that is located on an upper surface of the carpet and has hooks to be fastened to the insertion grooves formed in a front section thereof and a protrusion to which the mat is fitted formed in a upper part thereof; a column that passes through a hole of the carpet and vertically connects a rear section of the lower plate and a rear section of the upper plate; and a pressing unit that is formed by a flexible material to enhance a fixing force of the clip to the carpet by pressing the carpet section fitted between the upper plate and the lower plate upward when the upper plate and the lower plate are fastened, has an annular longitudinal sectional surface, and by which the upper part and the lower part gradually come closer to each other when the upper plate and the lower plate are fastened.

Patent Document 2 relates to a vehicle carpet reinforcing structure which reinforces a vehicle carpet to be fixed with a mat using a fixing clip, and a method of manufacturing the same. The vehicle carpet reinforcing structure includes a body that is located to correspond to a lower part of the fixing clip and has a plate shape body; and a fixing unit installed on one side of the body to fix the body to the carpet. According to the vehicle carpet reinforcing structure and method of manufacturing the same of Patent Document 2, by reinforcing the carpet to correspond to a bottom surface of the fixing clip for fixing the mat, it is possible to suppress the damage or deformation of the carpet due to the movement of the fixing clip and to extend the lifetime of the carpet.

However, such conventional clips have the following problems:

(1) Since the clip is fixed to the carpet in the form of an elastic piece, when a weak impact is applied to the clip, the elastic piece is easily unfixed, and the clip may be detached from the carpet;

(2) The mat fixed to the clip deviates from its original position due to the detachment of the clip, and there is an inconvenience in that the mat is required to be fixed at its original position again or repositioned;

(3) When the clip is frequently unhooked or does not work due to damage or the like, since there is a need to replace the clip with a new one, there is an inconvenience in maintenance;

(4) In particular, since the fixing unit of the clip made in the form of the elastic piece loses elasticity over time, ultimately, the clip may be detached from the carpet; and

(5) Since the elastic piece has a form in which it is hooked on only one side, when loads are applied to the clip from several directions, the clip is easily unhooked, and the clip may be detached from the carpet.

Patent Document 1 Korean Patent No. 10-0971253 (registration date: Jul. 13, 2010)

Patent Document 2 Korean Patent No. 10-1210463 (registration date: Dec. 4, 2012)

### DISCLOSURE

### Technical Problem

The present invention is directed to provide a clip for fixing a mat of a carpet of a vehicle that prevents the clip once mounted to the carpet from being detached to improve the coupling force, by fixing the clip to the carpet in the form of a cable tie.

In particular, the present invention is directed to provide a clip for fixing a mat of a carpet of a vehicle that further enhances the coupling force of fixing the clip to the carpet to prevent weakening of the coupling force of the clip or detachment of the clip even when an external force is applied to the carpet, by forming a tongue section to further enhance the coupling force of the clip while being extended as the carpet is pressed on the mat.

### Technical Solution

One aspect of the present invention provides a clip for fixing a mat of a carpet of a vehicle which includes a body 100 which has a hook 110 formed on one side of the body to hook a mat M, and a fastener 200 to be fixed by being fitted to the carpet C and a plurality of crimping protrusions 120 contacting the carpet C included on the other side of the body, wherein the fastener 200 is configured to include a rotation support section 210 fitted into a mounting hole H1 formed through the carpet C at a predetermined position; a fixing section 220 that is fitted into another mounting hole H2 formed apart from the mounting hole H1 by a predetermined gap, and has a through-hole 221 formed on a tip side surface and equipped with an elastic piece 221a; and a tongue section 230 that is formed at the rotation support section 210 to rotate toward the fixing section 220 side, and has a plurality of hooking jaws 231 formed at the tip to be fitted into the through-hole 221 and sequentially hooked to the elastic piece 221a in one direction.

In particular, as the tongue section 230 is mounted by being fitted to the fixing section 220, hooking jaws 211 and 235 may be formed on surfaces of the rotation support section 210 and the tongue section 230 that face each other, and when the through-hole 231 of the tongue section 230 is mounted by being fitted to the hooking jaw 211, the hooking jaws 211 and 235 may be coupled to each other.

In addition, unlocking of the elastic piece 231a is enabled by cutting both side surfaces of the through-hole 231 through which the hooking jaw 221 passes to pass therethrough so that the elastic piece 231a is viewed from the outside.

Further, the tongue section 230 may be formed integrally with the rotation support section 210, and may be rotated by being connected by a weakened section 232 having a thin thickness.

Further, the tongue section 230 may be further formed with a weakened section 233 at an intermediate portion of its length so that it may be folded in the same direction as the rotation support section 210.

Finally, the tongue section 230 may have a pressing piece 234 that is further formed on a surface that faces the carpet C to be pressed in contact with the carpet C.

### Advantageous Effects

According to the clip for fixing the mat of the carpet of the vehicle of the present invention, there are following effects.

(1) As the clip is fitted to one side like a cable tie, the coupling force is persistently enhanced to prevent the clip from being easily detached from the carpet.

(2) Since the detachment of the clip is prevented in this manner, it is possible to maintain a position of hooking and mounting the mat.

(3) When a load is applied over the carpet, the tongue section is pressed and further firmly fixed to the fixing section to enhance the coupling force of the clip.

(4) Since the elastic piece is exposed to the outside while enhancing the coupling force with the carpet, it is possible to release the coupling force of the clip by a simple operation of tilting it.

(5) Thus, when the clip is damaged and the clip is replaced or the carpet or the like is exchanged, the clip can be easily attached and detached.

(6) Since the clip is mounted on the carpet through the coupling of the cable tie type and the coupling type of the crimping protrusions and the hooking jaws, it is possible to prevent the clip from being easily detached.

(7) Since the clip is integrally manufactured, the clip is easily manufactured, and the assembling process may be omitted. Accordingly, the clip can be mass-produced.

### DESCRIPTION OF DRAWINGS

FIG. 1 is a cross-sectional view illustrating a state in which a clip is mounted on a carpet and then a mat is fitted thereon to explain a configuration of a clip according to the present invention.

FIG. 2 is a cross-sectional view illustrating a state in which the clip according to the present invention is fitted to a mounting hole to mount the clip to a carpet.

FIG. 3 is a cross-sectional view illustrating a state in which a tongue section is fitted and fixed to a fixing section, while fitting the clip according to the present invention to the mounting hole.

FIG. 4 is a cross-sectional view illustrating a state in which the clip according to the present invention is mounted to the carpet and the mat is mounted on the clip.

### MODES OF THE INVENTION

Hereinafter, exemplary embodiments of the present invention will be described in greater detail. However, the terms or words used in the specification and claims are not to be interpreted by their typical or dictionary meanings but their meanings and concepts should be construed in conformity with the technical idea of the invention, based on the principle that the inventor can properly define the concepts of the terms to explain the invention in the best manner.

Therefore, since the exemplary embodiments described herein and the configurations illustrated in drawings are merely the most preferred embodiments of the present invention and are not intended to limit all the technical ideas of the present invention, it should be understood that there may be variations, equivalents or modifications capable of replacing them at the time of filing of this application.

(Configuration)

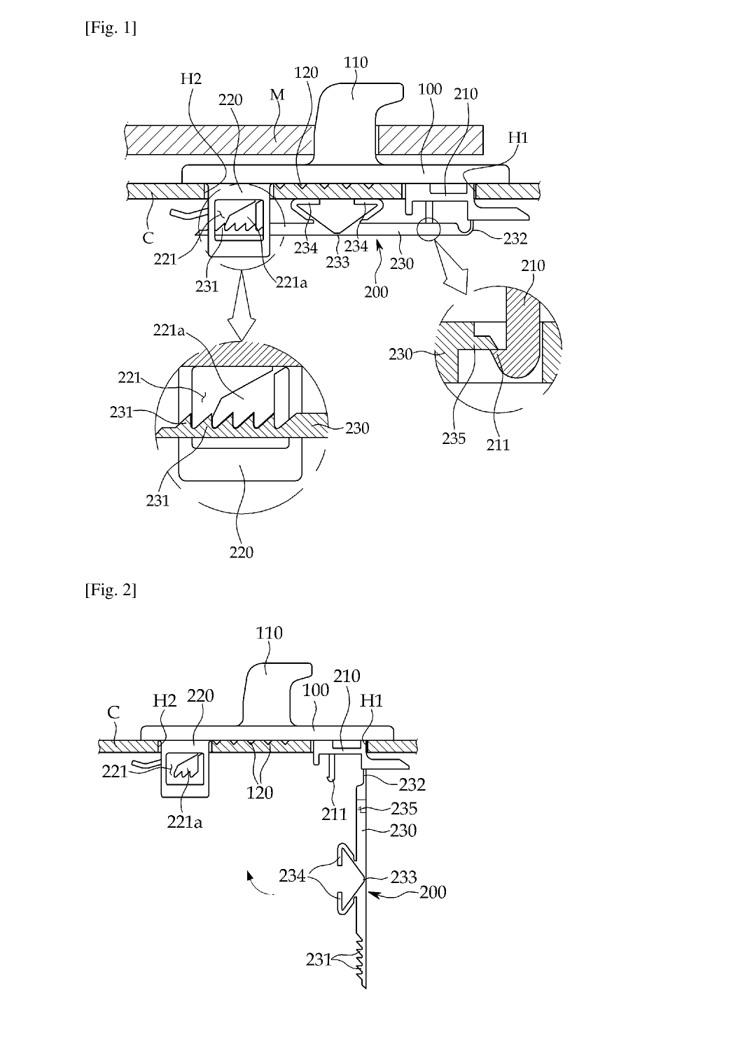

As illustrated in FIGS. 1 to 4, a clip for fixing a mat of a carpet of a vehicle according to the present invention is configured to include a body 100, one side of which has a hook 110 formed to hook the mat M, and the other side of which has a fastener 200 formed to fix the clip according to the present invention to the carpet C.

In particular, the fastener 200 is configured to include a rotation support section 210 and a fixing section 220 formed to protrude from the body 100 at a predetermined interval, and a tongue section 230 that is rotatably formed on the rotation support section 210 and one side of which is coupled to the fixing section 220 in the same manner as a cable tie.

Thus, the tongue section 230 firmly fixes the clip to the carpet to prevent the clip from being detached from the carpet C, and as the clip C is pressed, the clip can be more firmly fixed to the carpet C.

Hereinafter, each component according to the present invention will be specifically described below. Here, the carpet C is manufactured by a conventional technique of mounting it in a vehicle, and two mounting holes H1 and H2 are formed to pass through the mat M and mount the clip used to fit and fix the mat M. Further, the mat M mounted on the carpet C is also manufactured by a conventional technique.

As illustrated in FIG. 1, the body 100 is configured so that the mat M may be hooked thereon while fixed to the carpet C. To this end, the hook 110 is formed on one surface (an upper surface in the drawings) to hook the mat M.

As illustrated in FIG. 1, the body 100 is formed with a plurality of crimping protrusions 120 and the fastener 200 for substantially fixing the carpet C to the other surface. The crimping protrusions 120 are pressed as the body 100 comes into close contact with the carpet C, and the crimping protrusions 120 become embedded in the carpet C like wedges to enhance the coupling force to the body 100.

As illustrated in FIGS. 1 and 2, the fastener 200 includes the rotation support section 210 and the fixing section 220 formed to protrude from the body 100, and the tongue section 230 rotatably mounted on the rotation support section 210 and mounted to the fixing section 220 in the same manner as a cable tie to fix the carpet C.

As illustrated in FIGS. 1 and 2, the rotation support section 210 is formed to protrude from the body 100 to be able to be inserted into the mounting hole H1 formed to pass through the carpet C. Although the rotation support section 210 may be mounted as a separate configuration by being configured separately from the body 100, it is desirable to fabricate the rotation support section 210 formed integrally with the body 100 using the same material as the body 100.

Further, a hooking jaw 211 is formed in the tip portion of the rotation support section 210 which protrudes from the body 100. At this time, the hooking jaw 211 is formed at a position that may be meshed with a hooking jaw 235 formed in a tongue section 230 to be described below when the tongue section 230 is rotated to be coupled therewith.

The tongue section 230 is mounted on the rotation support section 210 configured in this way to be rotatable toward the fixing section 220.

As illustrated in FIGS. 1 and 2, the fixing section 220 is formed in the body 100 to correspond to a position at which it may be inserted into the other mounting hole H2 formed in the carpet C. The fixing section 220 may also be formed integrally with the body 100 similarly to the rotation support section 210, or may be mounted by being separately manufactured.

In particular, a through-hole 221 is formed in the fixing section 220 on the surface facing the rotation support section 210 such that the tip end of the tongue section 230 can be fitted. In this case, it will form an elastic piece 221a in the through-hole 221. The elastic piece 221a serves as hooking, while a plurality of hooking jaws 231 formed in the tongue section 230 in the lengthwise direction is deformed as the tongue section 230 is fitted to the through-hole 221.

Also, in a preferred embodiment of the present invention, it is desirable to form the fixing section 220 so that the elastic piece 221a can be viewed by cutting both sides of the through-hole 221. The reason is as follows. When the hooking jaw 231 is hooked by the elastic piece 221a, the hooking is not released. However, when there is a need to release the hooking such as a case of replacing the broken or damaged clip, a tool such as a driver is fitted into the cut section to unlock the elastic member 221a.

As illustrated in FIGS. 1 and 2, the tongue section 230 is manufactured in the form of a strip slightly longer than the length between the rotation support section 210 and the fixing section 220. The tongue section 230 is supported by the rotation support section 210 at one end and is mounted to be rotatable in a direction of the fixing section 220.

In a preferred embodiment of the present invention, it is desirable to manufacture the tongue section 230 by a flexible material so that its tip can be easily connected to the through-hole 221. At this time, as its material, it is desirable to use the same synthetic resin as the body 100, and although the tongue section 230 may be fixed to the tip of the rotation support section using a screw 210 or the like by being manufactured separately from the body 100, it is desirable to form the tongue section 230 integrally with the rotation support section 210.

Also, in the preferred embodiment of the present invention, when integrally forming the rotation support section 210 and the tongue section 230, the connection portion is thinly connected to the other portion by the weakened section 232, and thus, it is desirable that the tongue section 230 can easily rotate around the rotation support section 210.

The distal end of the tongue section 230 is fitted into the through-hole 221, and a plurality of locking jaws 231 are formed on the surface facing the elastic piece 221a at predetermined gaps. At this time, the hooking jaw 231 is formed so that the tongue section 230 can be fitted only in one direction.

Meanwhile, as illustrated in FIGS. 1 and 2, in the tongue section 230, another hooking jaw 235 is formed at a position facing the hooking jaw 211. The hooking jaws 211 and 235 are engaged with each other to enhance the coupling force between the rotation support section 210 and the tongue section 230 as the other side of the tongue section 230 fixed to the rotation support section 210 at one side of the rotation support section 210 is fitted to the through-hole 230.

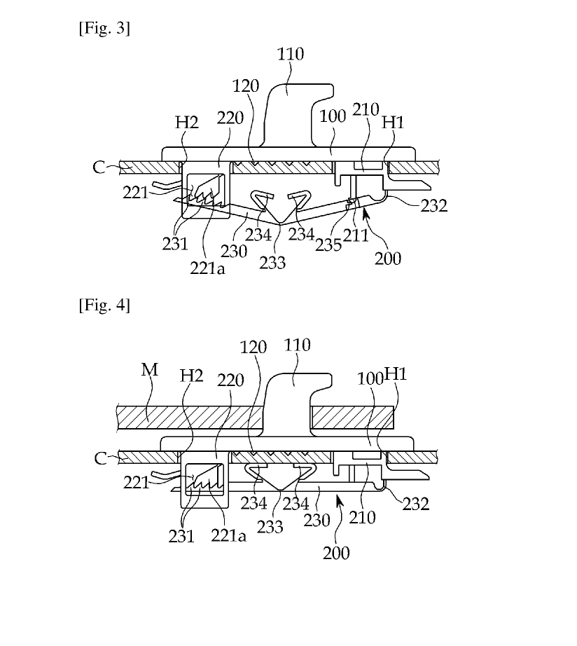

Also, in the preferred embodiment of the present invention, as illustrated in FIGS. 1 and 2, in the tongue section 230, it is desirable to form another weakened section 233 in the intermediate portion of its length. This is intended to allow the easier connection of the distal end to the through-hole 221, and as illustrated in FIG. 3, it is desirable to form the weakened section 233 to be foldable to the outside of the carpet C.

In the preferred embodiment of the present invention, as illustrated in FIGS. 1 and 2, the tongue section 230 is desirably formed with an additional pressing piece 234 on a surface that faces the carpet C. The pressing piece 234 causes deformation between the tongue section 230 and the carpet C as the hooking jaw 221 is inserted into the through-hole 231 of the tongue section 230, and applies predetermined tension between the tongue section 230 and the carpet C, thereby obtaining an effect of preventing the clip according to the present invention from being detached from the carpet C.

(Coupling of Carpet and Mat)

The clip according to the present invention thus configured couples the carpet C and mat M in the order as illustrated in FIGS. 2 to 4.

First, the clip according to the present invention is coupled to the carpet C. As illustrated in FIG. 2, each of the rotation support section 210 and the fixing section 220 is fitted into the mounting holes H1 and H2 in the unfolded state of the tongue section 230. The tongue section 230 rotates in the direction of an arrow in FIG. 2. At this time, the tongue section 230 easily rotates around the weakened section 232.

Subsequently, as illustrated in FIG. 3, the tip of tongue section 230 is fitted into the through-hole 221. At this time, the tongue section 230 is easily fitted, while being folded in the “V” shape as illustrated in FIG. 3 due to another weakened section 233.

The fitted tongue section 230 fixes the carpet C, as the bent shape is unfolded flat, while the elastic piece 211a goes over the hooking jaw 231.

Meanwhile, in this way, as the tongue section 230 fixes the carpet C, the crimping protrusions 120 formed in the body 100 fix the carpet C under pressure, and the crimping piece 234 enhances the mounting force of the carpet C, while being pressed and deformed by the carpet C and the tongue section 230.

Finally, when the mat M is located over the carpet C and the mounting hole formed in the mat M is hooked by a hook 110 formed on the body 100, the mounting work is completed.

As described above, the present invention can prevent the clip from being easily detached from the carpet, when mounting and fixing the clip to the carpet, by adopting a method such as a cable tie.

1-6. (canceled)

7. A clip for fixing a mat of a carpet of a vehicle comprising a body which has a hook formed on one side of the body to hook a mat, and a fastener to be fixed by being fitted to a carpet and a plurality of crimping protrusions contacting the carpet included on the other side of the body,
wherein the fastener comprises:
a rotation support section fitted into a mounting hole H1 formed through the carpet at a predetermined position;
a fixing section that is fitted into another mounting hole H2 formed apart from the mounting hole H1 by a predetermined gap, and has a through-hole formed on a tip side surface and equipped with an elastic piece; and
a tongue section that is formed at the rotation support section to rotate toward the fixing section side, and has a plurality of hooking jaws formed at the tip to be fitted into the through-hole and sequentially hooked to the elastic piece in one direction.

8. The clip for fixing the mat of the carpet of the vehicle of claim 7, wherein as the tongue section is mounted by being fitted to the fixing section, each of the plurality of hooking jaws is formed on a surface in which the support section faces the tongue section, and when the tongue section is mounted by being fitted into the through-hole, the tongue section and the through-hole are coupled to each other.

9. The clip for fixing the mat of the carpet of the vehicle of claim 7, wherein, by cutting both side surfaces of the through-hole in which the tongue section passes through so that the elastic piece can be viewed from the outside, the elastic piece can be unlocked.

10. The clip for fixing the mat of the carpet of the vehicle of claim 7, wherein the tongue section is formed integrally with the rotation support section, and rotates by being connected by a weakened section having a thin thickness.

11. The clip for fixing the mat of the carpet of the vehicle of claim 7, wherein the tongue section is further formed with a weakened section at an intermediate portion of its length so as to be foldable in the same direction as the rotation support section.

12. The clip for fixing the mat of the carpet of the vehicle of claim 8, wherein the tongue section is further formed with a weakened section at an intermediate portion of its length so as to be foldable in the same direction as the rotation support section.

13. The clip for fixing the mat of the carpet of the vehicle of claim 9, wherein the tongue section is further formed with a weakened section at an intermediate portion of its length so as to be foldable in the same direction as the rotation support section.

14. The clip for fixing the mat of the carpet of the vehicle of claim 10, wherein the tongue section is further formed with a weakened section at an intermediate portion of its length so as to be foldable in the same direction as the rotation support section.

15. The clip for fixing the mat of the carpet of the vehicle of claim 11, wherein the tongue section is further formed with a crimping piece on a surface that faces the carpet so as to be pressed to contact the carpet.

16. The clip for fixing the mat of the carpet of the vehicle of claim 12, wherein the tongue section is further formed with a crimping piece on a surface that faces the carpet so as to be pressed to contact the carpet.

17. The clip for fixing the mat of the carpet of the vehicle of claim 13, wherein the tongue section is further formed with a crimping piece on a surface that faces the carpet so as to be pressed to contact the carpet.

18. The clip for fixing the mat of the carpet of the vehicle of claim 14, wherein the tongue section is further formed with a crimping piece on a surface that faces the carpet so as to be pressed to contact the carpet.
